(19) United States
(12) Patent Application Publication
(10) Pub. No.: US 2024/0308435 A1
(43) Pub. Date: Sep. 19, 2024

(54) VEHICLE-MOUNTED VOICE REMOTE CONTROL DEVICE

(71) Applicant: Shenzhen Coroads electronics limited, SHENZHEN (CN)

(72) Inventors: JIANHONG WU, SHENZHEN (CN); JIANG HUA, SHENZHEN (CN)

(21) Appl. No.: 18/676,497

(22) Filed: May 28, 2024

Related U.S. Application Data
(63) Continuation of application No. PCT/CN2022/130467, filed on Nov. 8, 2022.

(30) Foreign Application Priority Data
Dec. 15, 2021 (CN) 202123147901.8

(51) Int. Cl. B60R 11/00; G10L 15/22

(52) U.S. Cl. CPC B60R 11/00; G10L 15/22; B60R 2011/001; B60R 2011/0057; B60R 2011/0059

(57) ABSTRACT

The present invention provides a vehicle-mounted voice remote control device which comprises a voice remote control main body and an assembly component, wherein the assembly component comprises an assembly shell and a binding belt fixed on the assembly shell, the binding belt is used for binding a column in a vehicle, the voice remote control main body is detachably assembled on the assembly shell, and the voice remote control main body comprises a wireless communication module communicated with a mobile terminal and used for voice interaction with the mobile terminal. This vehicle-mounted voice remote control device can be connected with the mobile terminal communication to realize pronunciation regulation and control mobile terminal through this vehicle-mounted voice remote control device, this vehicle-mounted voice remote control device includes the binding belt, and through the mode of binding belt, it is more convenient to vehicle-mounted voice remote control device's installation for the user, satisfies the user and awakens up to mobile terminal's pronunciation, with liberation both hands, thereby can drive safely.

### CROSS REFERENCE TO RELATED APPLICATION

This application is a continuation of International Patent Application No. PCT/CN2022/130467 with a filing date of Aug. 2, 2022, designating the United States, now pending, and further claims priority to Chinese patent application CN 202123147901.8 with a filing date of Nov. 8, 2022. The content of the aforementioned applications, including any intervening amendments thereto, are incorporated herein by reference.

### TECHNICAL FIELD

The present invention relates to the technical field of vehicle-mounted communication, in particular to a vehicle-mounted voice remote control device.

### BACKGROUND

In the driving process, a driver needs to concentrate on driving, so that the driver cannot be distracted to operate a mobile phone or other mobile terminals, such as answering a call, navigating, checking weather forecast or playing songs and the like. Therefore, a driver wants to control the mobile terminal in the driving process, and much trouble is brought, and if the driver manually operates, potential safety hazards are caused.

### DISCLOSURE OF INVENTION

The present invention aims to provide an intelligent interactive vehicle-mounted voice remote control device aiming at the defects in the prior art.

In order to achieve the above purpose, the embodiment of the present invention adopts the following technical solutions:

The embodiment of the present invention provides a vehicle-mounted voice remote control device which comprises a voice remote control main body and an assembly component, wherein the assembly component comprises an assembly shell and a binding belt fixed on the assembly shell, the binding belt is used for binding a column in a vehicle, the voice remote control main body is detachably assembled on the assembly shell, and the voice remote control main body comprises a wireless communication module communicated with a mobile terminal and used for voice interaction with the mobile terminal.

Preferably, the voice remote control main body comprises an upper case, a lower case assembled on the upper case, and a control panel installed in a space formed by the upper case and the lower case, wherein the control panel comprises the wireless communication module; wherein the control panel further comprises a voice recognition module.

Preferably, the upper case is a tawny lens, and a silicone keyboard is assembled on the tawny lens and corresponds to the control switch on the control panel.

Preferably, the voice remote control main body further comprises a battery electrically connected with the control panel, and the battery being located between the control panel and the lower case.

Preferably, the voice remote control main body further comprises a magnetic part, and a magnetic attraction piece magnetically attracted with the magnetic member is provided in the assembly shell.

Preferably, the magnetic member is disposed between the battery and the lower case, and the magnetic member is adhered to the lower case.

Preferably, the assembly component further comprises a decoration piece, and the decoration piece is adhered to the bottom surface of the assembly shell so as to enclose the magnetic attraction piece on the bottom surface of the assembly shell.

Preferably, the voice remote control main body further comprises a data interface disposed on the lower case, and the data interface is electrically connected to the control panel.

Preferably, the side wall and/or the bottom wall of the assembly shell is provided with anti-slip silicone to be assembled with the voice remote control main body through overmolding or double molding injection.

Preferably, one end of the binding belt is fixed to the bottom of a side surface of the assembly shell, a tension column around which the binding belt is wound is provided on the assembly shell, and the tension column is fitted to a top of a side surface of the assembly shell.

The vehicle-mounted voice remote control device in the technical scheme provided by the embodiment of the present invention can be in communication connection with the mobile terminal so as to realize voice regulation and control of the mobile terminal through the vehicle-mounted voice remote control device, the vehicle-mounted voice remote control device comprises a binding belt, and the user can install the vehicle-mounted voice remote control device more conveniently by means of magic tape, so that voice awakening of the user on the mobile terminal is met, two hands are liberated, and safe driving is realized.

### DRAWINGS

In order to more clearly illustrate the technical solutions of the embodiments of the present invention, the drawings required in the embodiments will be briefly described below, it should be understood that the following drawings only illustrate some embodiments of the present invention and therefore should not be considered as limiting the scope, and those skilled in the art can also obtain other related drawings based on the drawings without inventive efforts.

FIG. 1 is a schematic structural diagram of a vehicle-mounted voice remote control device according to an embodiment of the present invention;

FIG. 2 is an exploded view of a vehicle-mounted voice remote control device according to an embodiment of the present invention;

FIG. 3a is assembly diagrams of a vehicle-mounted voice remote control device and a steering wheel according to an embodiment of the present invention;

FIG. 3b is assembly diagrams of a vehicle-mounted voice remote control device and a steering wheel according to an embodiment of the present invention;

FIG. 3c is assembly diagrams of a vehicle-mounted voice remote control device and a steering wheel according to an embodiment of the present invention;

FIG. 4a is schematic structural diagram illustrating a voice remote control main body of a vehicle-mounted voice remote control device being assembled to an assembly housing according to an embodiment of the present invention.

FIG. 4b is schematic structural diagram illustrating a voice remote control main body of a vehicle-mounted voice remote control device being assembled to an assembly housing according to an embodiment of the present invention.

### DETAILED DESCRIPTION

In order to make the objects, technical solutions and advantages of the embodiments of the present invention clearer, the technical solutions in the embodiments of the present invention will be clearly and completely described below with reference to the drawings in the embodiments of the present invention, and it is obvious that the described embodiments are some, but not all embodiments of the present invention. The components of embodiments of the present invention generally described and illustrated in the figures herein may be arranged and designed in a wide variety of different configurations.

Thus, the following detailed description of the embodiments of the present invention, as presented in the figures, is not intended to limit the scope of the present invention, as claimed, but is merely representative of selected embodiments of the utility model. It should be noted that, in case of conflict, various features of the embodiments of the present invention may be combined with each other, and the combined embodiments still fall within the scope of the present invention.

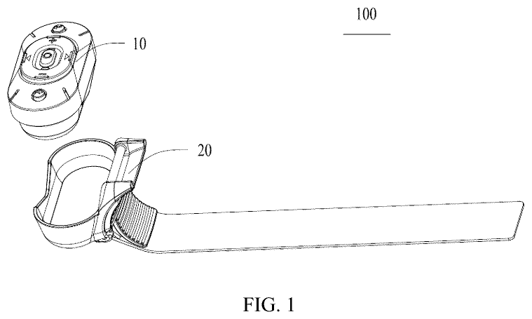

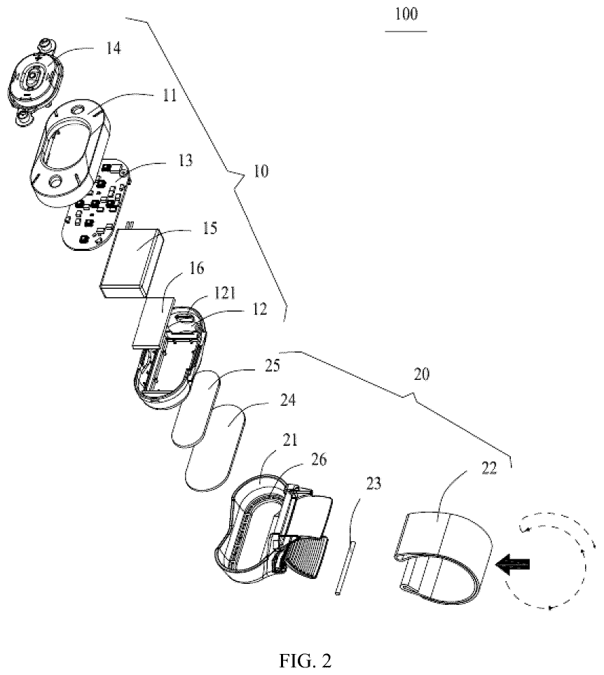

As shown in FIG. 1 and FIG. 2, FIG. 1 is a schematic structural diagram of a vehicle-mounted voice remote control device according to an embodiment of the present invention; FIG. 2 is an exploded view of a vehicle-mounted voice remote control device according to an embodiment of the present invention, in which a dotted line indicates an assembly direction of a strap, and the strap is specifically folded from bottom to top and then fixed by a hook and loop fastener. The vehicle-mounted voice remote control device 100 of the embodiment of the present invention includes a voice remote control main body 10 and assembly component 20.

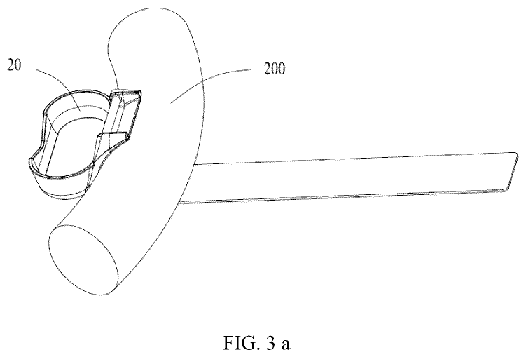

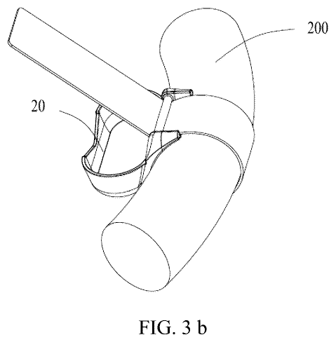

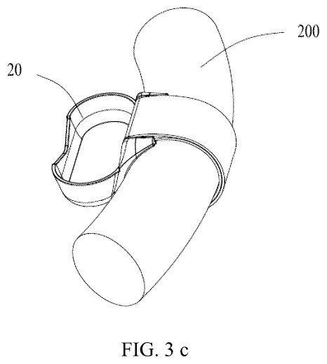

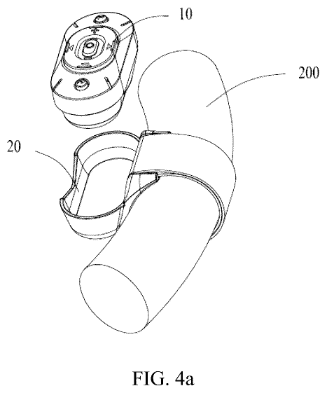

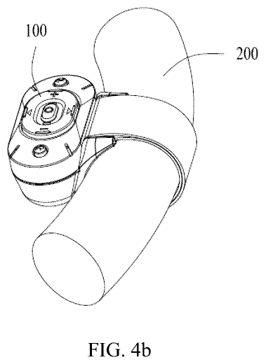

As shown in FIG. 3a to FIG. 3c and FIG. 4a to FIG. 4b, the assembly component 20 includes an assembly shell 21 and a binding belt 22 fixed to the assembly shell 21. Wherein, the binding belt 22 in this embodiment is a silicone binding belt. The binding belt 22 is used binding a column 200 in the vehicle, and the voice remote control main body 10 is detachably attached to the assembly shell 21. In the embodiment of the present invention, the column 200 is a steering wheel, and the vehicle-mounted voice remote control device 100 is bound to the steering wheel, so that the voice control of the driver is facilitated, and the driving of the driver is not affected. In other embodiments, the column 200 may also be other structural members in a vehicle, and is not particularly limited herein.

Wherein, one end of the binding belt 22 is fixed on the bottom of the side surface of the assembly shell 21, the assembly shell 21 is provided with a tension column 23 for the binding belt 22 to wind, and the tension column 23 is assembled on the top of the side surface of the assembly shell 21. The tension column 23 is provided on the same side of the assembly shell 21 as the binding belt 22.

In one embodiment, the top end of the side surface extends out of the mounting bracket, and the tension column 23 is suspended on the mounting bracket in a clamping manner at two ends. When the binding belt 22 is tied, the binding belt 22 passes through the steering wheel from the lower part of the tension column 23 and then reversely turns back, and is adhered by the magic tape arranged on the binding belt 22. Of course, the fixing manner of the binding belt 22 in the present invention is not limited to this, and other fixing manners by fitting are also applicable to the binding belt 22 in the present invention.

Wherein, the side wall and/or the bottom wall of the assembly shell 21 are/is further provided with anti-slip silicone 26 to be assembled with the voice remote control main body 10 through overmolding or double molding injection. Specifically, the vehicle-mounted voice remote control main body is provided with plastic, and the anti-slip silicone 26 is combined with the plastic through overmolding or double molding injection, so that the combination of the anti-slip silicone 26 and the steering wheel is more stable. After the voice remote control main body 10 is assembled in the assembly shell 21, the voice remote control main body 10 is attached to the protective anti-slip silicone 26, so as to prevent the voice remote control main body 10 from easily sliding out of the assembly shell 21 or easily moving relative to the assembly shell 21 after being assembled in the assembly shell 21.

Further, referring again to FIG. 1 and FIG. 2, the voice remote control main body 10 includes a wireless communication module for communicating with a mobile terminal to interact with the mobile terminal by voice, so that the mobile terminal including a mobile phone, a tablet computer, a business electronic device, etc. can be controlled by voice. In the embodiment, the mobile terminal takes a mobile phone as an example, and the mobile phone can be controlled by voice to answer a call, navigate, check weather forecast or play songs and the like. The mobile phone and the voice remote control main body 10 may perform data interaction through communication modes such as bluetooth, network signals, infrared signals, radio frequency signals, and the like, and an app or applet that is in communication with the voice remote control main body 10 may be installed on the mobile phone, so as to facilitate data interaction.

The voice remote control main body 10 includes an upper case 11, a lower case 12 assembled to the upper case 11, and a control panel 13 installed in a space formed by the upper case 11 and the lower case 12. The control panel 13 may be fixed in the upper case 11 or the lower case 12. The control panel 13 includes the above wireless communication module. The control panel 13 further includes a voice recognition module, which can recognize the voice of the user and convert the voice into data recognizable by the mobile phone for interaction.

In the embodiment of the present invention, the upper case 11 is a tawny lens, a silicone keyboard 14 is installed on the tawny lens, and the silicone keyboard 14 corresponds to the control switch on the control panel 13. The regulation and control switches comprise on-off setting, signal matching regulation and the like.

Further, the voice remote control main body 10 further includes a battery 15 electrically connected to the control panel 13, and the battery 15 is used for supplying power to the control panel 13. In this embodiment, the battery 15 is located between the control panel 13 and the lower case 12.

The voice remote control main body 10 further includes a magnetic member 16. Correspondingly, a magnetic attraction piece 24 is disposed in the assembly shell 21 and magnetically attracts the magnetic member 16. The voice remote control main body 10 is absorbed in the assembling shell 21 by the cooperation of the magnetic member 16 and the magnetic attraction piece 24. Wherein the magnetic member 16 is a strong magnetic sheet, and the magnetic attraction piece 24 is an iron sheet or a magnetic sheet. In the embodiment of the present invention, the magnetic member 16 is disposed between the battery 15 and the lower case 12, and the magnetic member 16 is adhered to the lower case 12.

The assembly component 20 of the present invention further comprises a decoration piece 25, wherein the decoration piece 25 may be leather, and the decoration piece 25 is adhered to the bottom surface of the assembly shell 21 to enclose the magnetic member 24 on the bottom surface of the assembly shell 21, so as to maintain the overall beauty of the assembly shell 21 and hide the magnetic attraction piece 24 in the assembly shell 21.

In addition, the voice remote control main body 10 further includes a data interface 121 disposed on the lower case 12, and the data interface 121 is electrically connected to the control panel 13, and is used for performing data interaction or charging with an external device.

The vehicle-mounted voice remote control device can be in communication connection with the mobile terminal, so that voice interaction is realized through the vehicle-mounted voice remote control device to regulate and control the mobile terminal, the vehicle-mounted voice remote control device comprises a binding belt, a user can install the vehicle-mounted voice remote control device more conveniently in a binding belt mode, voice awakening of the user on the mobile terminal is met, two hands are liberated, and the purpose of safe driving can be achieved by the user with hands on a steering wheel and eyes on the road in the driving process.

While preferred embodiments of the present invention have been described, additional variations and modifications of these embodiments may occur to those skilled in the art once they learn of the basic inventive concepts. Therefore, it is intended that the appended claims be interpreted as including the preferred embodiment and all changes and modifications that fall within the true scope of the embodiments of the present invention.

Finally, it should also be noted that, in this document, relational terms such as first and second, and the like are used solely to distinguish one entity or action from another entity or action without necessarily requiring or implying any actual such relationship or order between such entities or actions. Also, the terms “include”, “including” or any other variations thereof are intended to cover non-exclusive inclusion, so that a process, method, article, or electronic device including a series of elements includes not only those elements but also other elements not explicitly listed or inherent to such process, method, article, or electronic device. Without further limitation, an element defined by the phrase “comprising an . . . ” does not exclude the presence of other identical elements in the process, method, article, or electronic device that comprises the element.

The above description is only a preferred embodiment of the present invention and is not intended to limit the present invention, and various modifications and changes may be made by those skilled in the art. Any modification, equivalent replacement, or improvement made within the spirit and principle of the present invention should be included in the protection scope of the present invention.

We claim:

1. A vehicle-mounted voice remote control device is characterized by comprising a voice remote control main body and an assembly component, wherein the assembly component comprises an assembly shell and a binding belt fixed on the assembly shell, the binding belt is used for binding a column in a vehicle, the voice remote control main body is detachably assembled on the assembly shell, and the voice remote control main body comprises a wireless communication module communicated with a mobile terminal and used for voice interaction with the mobile terminal.

2. The vehicle-mounted voice remote control device according to claim 1, wherein the voice remote control main body includes an upper case, a lower case assembled to the upper case, and a control panel installed in a space formed by the upper case and the lower case, the control panel including the wireless communication module; wherein the control panel further comprises a voice recognition module.

3. The vehicle-mounted voice remote control device according to claim 2, wherein the upper case is a tawny lens, and a silicone key board is assembled on the tawny lens and corresponds to the control switch on the control panel.

4. The vehicle-mounted voice remote control device according to claim 2, wherein the voice remote control main body further comprises a battery electrically connected to the control panel, the battery being located between the control panel and the lower case.

5. The vehicle-mounted remote control device according to claim 4, wherein the voice remote control main body further comprises a magnetic member, and a magnetic attraction piece magnetically attracted with the magnetic member is provided in the assembly shell.

6. The vehicle-mounted voice remote control device according to claim 5, wherein the magnetic member is disposed between the battery and the lower case, and the magnetic member is bonded to the lower case.

7. The vehicle-mounted voice remote control device according to claim 5, wherein the assembly component further comprises a decoration piece, and the decoration piece is adhered to the bottom surface of the assembly shell so as to enclose the magnetic attraction piece on the bottom surface of the assembly shell.

8. The vehicle-mounted voice remote control device according to claim 2, wherein the voice remote control body further comprises a data interface disposed on the lowercase, and the data interface is electrically connected to the control panel.

9. The vehicle-mounted voice remote control device according to claim 1, wherein a side wall and/or a bottom wall of the assembly shell is further provided with an anti-slip silicone to be fitted with the voice remote control main body through overmolding or double molding injection.

10. The vehicle-mounted voice remote control device according to claim 1, wherein one end of the binding belt is fixed to a bottom of a side surface of the assembly shell, and a tension column around which the binding belt is wound is provided on the assembly shell, and the tension column is fitted to a top of a side surface of the assembly shell.
